(19) United States
(12) Patent Application Publication
(10) Pub. No.: US 2013/0181641 A1
(43) Pub. Date: Jul. 18, 2013

(54) UNIPOLAR SWITCHING APPARATUS OF SWITCHED RELUCTANCE MOTOR

(71) Applicants: Se Joon Kim, Gyunggi-do (KR); Sung Tai Jung, Gyunggi-do (KR); Han Kyung Bae, Gyunggi-do (KR); Hong Chul Shin, Gyunggi-do (KR); Guen Hong Lee, Gyunggi-do (KR)

(72) Inventors: Se Joon Kim, Gyunggi-do (KR); Sung Tai Jung, Gyunggi-do (KR); Han Kyung Bae, Gyunggi-do (KR); Hong Chul Shin, Gyunggi-do (KR); Guen Hong Lee, Gyunggi-do (KR)

(73) Assignee: SAMSUNG ELECTRO-MECHANICS CO., LTD., Gyunggi-do (KR)

(21) Appl. No.: 13/572,730

(22) Filed: Aug. 13, 2012

(30) Foreign Application Priority Data
Jan. 18, 2012 (KR) 10-2012-0005808

(51) Int. Cl. H02P 25/08

(52) U.S. Cl. 318/254.1

(57) ABSTRACT

Disclosed herein is a unipolar switching apparatus of a switched reluctance motor, including: a control unit outputting a unipolar switching control signal; and a transformer driving an SRM according to the unipolar switching control signal output from the control unit, thereby minimizing vibration and noise.

### CROSS REFERENCE TO RELATED APPLICATION

This application claims the benefit of Korean Patent Application No. 10-2012-0005808, filed on Jan. 18, 2012, entitled “Unipolar Switching Apparatus of The Switched Reluctance Motor”, which is hereby incorporated by reference in its entirety into this application.

### BACKGROUND OF THE INVENTION

1. Technical Field

The present invention relates to a unipolar switching apparatus for a switched reluctance motor.

2. Description of the Related Art

A switched reluctance motor (hereinafter, referred to as SRM) is a motor with which a switching apparatus is coupled, wherein both of a stator and a rotator has a salient pole type structure.

In particular, a winding is wound around only a stator but a rotor has no winding or permanent magnet, which results in making a structure of the switched reluctance motor simple.

Due the characteristics of the structure, it is significantly advantageous in manufacturing and production. The switched reluctance motor has excellent characteristics such as good starting property and torque like a DC motor, little maintenance, torque per a unit volume, efficiency, rating of a transformer, or the like. Therefore, the switched reluctance motor has been widely applied to various applications.

However, despite these advantages, the SRM generates noise and vibration higher than those of the existing driving apparatus.

Therefore, the SRM has been applied to applications less sensitive to noise, such as a mine, but may be hardly applied to home appliances, electric car, or the like. That is, in consideration of a torque generation mechanism of the SRM, the SRM is hardly applied to fields requiring a stillness operation due to torque, ripple, noise, or the like.

The noise is generated by vibrating a stator frame in a radial direction when each phase is turned on/off by tangential force and radial force mainly acting as rotating force during a process of generating the reluctance torque.

The tangential force acts as a rotating torque to a rotator, which generates an increase and decrease in a size, that is, torque pulsation according to a position angle of the rotator to degrade stability of torque-speed property of the motor.

The torque pulsation is generated due to pulsation in a torque generation period and incomplete inter-phase commutation.

Among them, the torque pulsation generated due to the incomplete inter-phase commutation greater appears. In order to reduce this, a method for appropriately overlapping the torque pulsation has been proposed.

Further, a noise and vibration generation factor is largely divided into a mechanical factor and an electromagnetic factor.

The noise is generated due to a problem of manufacturing such as concentricity of a core, straight, contact friction, weight unbalance, or the like, mechanical vibration at used parts such as a bearing, friction with air, or the like, as the mechanical factors.

As the electromagnetic factor, there may be a contraction and expansion action due to a sudden change in magnetomotive force generated at a turn on/off instant of a phase switch.

### RELATED ART DOCUMENT

### Patent Document

(Patent Document 1) KR Patent Laid-Open Publication No. 2002-0081862

### SUMMARY OF THE INVENTION

The present invention has been made in an effort to provide a unipolar switching apparatus of a switched reluctance motor capable of minimizing a sudden change in magnetomotive force by smoothly following a desired reference current.

According to a preferred embodiment of the present invention, there is provided a unipolar switching apparatus of a switched reluctance motor, including: a control unit outputting a unipolar switching control signal; and a transformer driving an SRM according to the unipolar switching control signal output from the control unit.

The transformer may include: a plurality of pairs of switches connected with each coil of the SRM in series; and a plurality of pairs of diodes connected with each corresponding switch in parallel so as to re-circulate winding current of the corresponding coil when any one of the pair of switches is turned off.

The transformer may further include a capacitor connected with both ends of the plurality of pairs of switches in parallel to smooth and provide reference power voltage.

The control unit may include: a reference wave generator generating and outputting a triangular wave that is reference voltage; a control signal generator outputting a control signal including a positive control signal, a 0 control signal, and a negative control signal in a turn on period of reference current of each coil; an inverter inverting and outputting the control signal output from the control signal generator; a first comparator comparing a triangular wave input from the reference wave generator with the control signal input from the control signal generator to output a switching control signal of an upper switch; and a second comparator comparing a triangular wave input from the reference wave generator with an inversion control signal output from the inverter to output a switching control signal of a lower switch.

The transformer according to the unipolar switching control signal output from the control unit may apply source power voltage to the corresponding coil and then, apply 0 voltage thereto and apply −source power voltage thereto to activate the corresponding coil.

The transformer according to the unipolar switching control signal output from the control unit may apply the source power voltage temporarily having the 0 voltage halfway to the corresponding coil and then apply 0 voltage thereto and apply −source power voltage temporarily having a 0 voltage state halfway thereto to activate the corresponding coil.

According to another preferred embodiment of the present invention, there is provided a unipolar switching apparatus of a switched reluctance motor, including: a transformer including a plurality of a pair of switches connected with each coil of an SRM in series, including a mode 1 state in which a pair of switches is turned on, a mode 2 state in which a pair of switches is turned off, a mode 3 state in which an upper switch is turned on and a lower switch is turned off, among a pair of switches, and a mode 4 state in which an upper switch is turned off and a lower switch is turned on, among a pair of switches, and using the modes 1 to 4 states according to a unipolar switching control signal to drive the SRM; and a control unit outputting a unipolar switching control signal to the transformer, wherein the transformer according to the unipolar switching control signal output from the control unit applies source power voltage to a corresponding coil, applies 0 voltage thereto, and then −source power voltage thereto to activate the corresponding coil.

The unipolar switching control signal output to the transformer from the control unit may change the state of the transformer from a mode 1 state to a mode 3 or 4 state and a mode 2 state.

### BRIEF DESCRIPTION OF THE DRAWINGS

FIG. 1 is a configuration diagram of a unipolar switching apparatus for a switched reluctance motor according to a first preferred embodiment of the present invention;

FIG. 2 is a circuit diagram of a transformer of FIG. 1;

FIGS. 3A to 3D are exemplified diagrams showing an operation mode of the transformer of FIG. 1;

FIG. 4 is an exemplified diagram showing a desired reference current to be induced to each coil;

FIG. 5A is a diagram showing a turn on or off of an upper switch and FIG. 5B is a diagram showing a turn on or off of a lower switch;

FIG. 6 is an exemplified diagram of voltage applied to the corresponding coil;

FIG. 7A is a diagram showing another preferred embodiment of a turn on or off of an upper switch and FIG. 7B is a diagram showing another preferred embodiment of a turn on or off of a lower switch;

FIG. 8 is another exemplified diagram of voltage applied to the corresponding coil;

FIG. 9 is an exemplified diagram showing following current for reference current;

FIG. 10 is a detailed block diagram of a control unit of FIG. 1;

FIG. 11 is an exemplified diagram of a reference wave generated from a reference wave generator, a control signal generated from a control signal generator, and an inversion control signal generated from an inverter;

FIG. 12 is an exemplified diagram of a control signal of the upper switch generated by a first comparator of FIG. 10;

FIG. 13 is an exemplified diagram of a control signal of the lower switch generated by a second comparator of FIG. 10;

FIG. 14 is an exemplified diagram of a reference wave generated from a reference wave generator, a control signal generated from a control signal generator, and an inversion control signal generated from an inverter, shown in FIG. 10;

FIG. 15 is another exemplified diagram of a control signal of the upper switch generated by a first comparator of FIG. 10; and

FIG. 16 is another exemplified diagram of a control signal of the lower switch generated by a second comparator of FIG. 10.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the present invention may be modified in various different ways and is not limited to the preferred embodiments provided in the present description. Further, in describing the present invention, a detailed description of related known functions or configurations will be omitted so as not to obscure the subject of the present invention.

Hereinafter, preferred embodiments of the present invention will be described in detail with reference to the accompanying drawings.

FIG. 1 is a configuration diagram of a unipolar switching apparatus for a switched reluctance motor according to a first preferred embodiment of the present invention.

Referring to FIG. 1, a unipolar switching apparatus of a switched reluctance motor according to a first preferred embodiment of the present invention may include a transformer 100 driving an SRM 300 according to a unipolar switching control signal output from a control 200 and a control unit 200 outputting the unipolar switching control signal to the transformer 100.

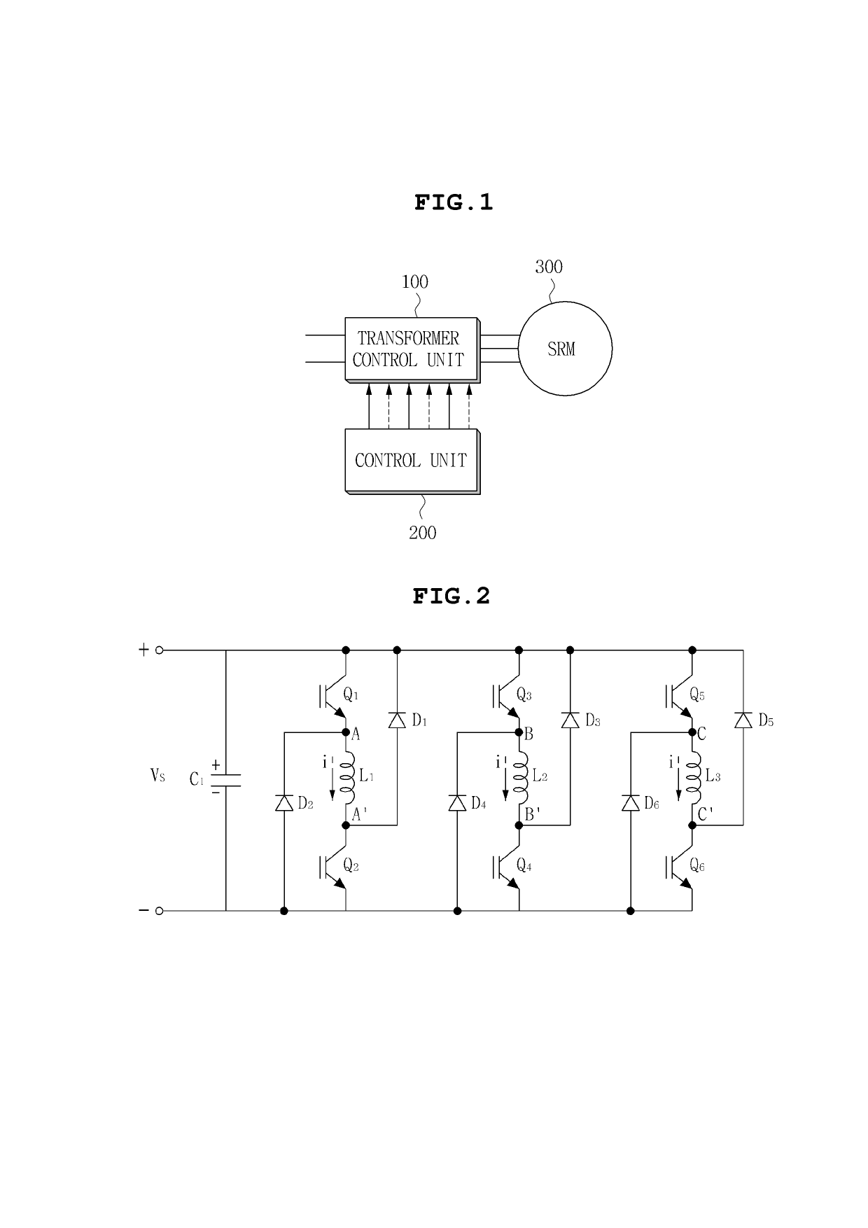

As shown in FIG. 2, in the transformer 100, a pair of switches configured of upper switches Q₁, Q₃, and Q₅ and lower switches Q₂, Q₄, and Q₆ is connected with each coil L₁, L₂, and L₃.

Further, the transformer 100 includes upper diodes D₁, D₃, and D₅ corresponding to the upper switches Q₁, Q₃, and Q₅ so as to re-circulate winding current of the corresponding coils L₁, L₂, and L₃ and a pair of diodes configured of lower diodes D₂, D₄, and D₆ corresponding to the lower switches Q₂, Q₄, and Q₆, when any one of the pair of switches is turned off.

In this configuration, the capacitor C₁ is connected with a source power supply in parallel to smooth and output source power voltage Vs.

The transformer 100 of the switched reluctance motor configured as described above sequentially actives the coils L₁, L₂, and L₃ so as to generate positive torque to a rotator disposed in a stator of the switched reluctance motor. To this end, the transformer 100 has four modes (modes 1 to 4).

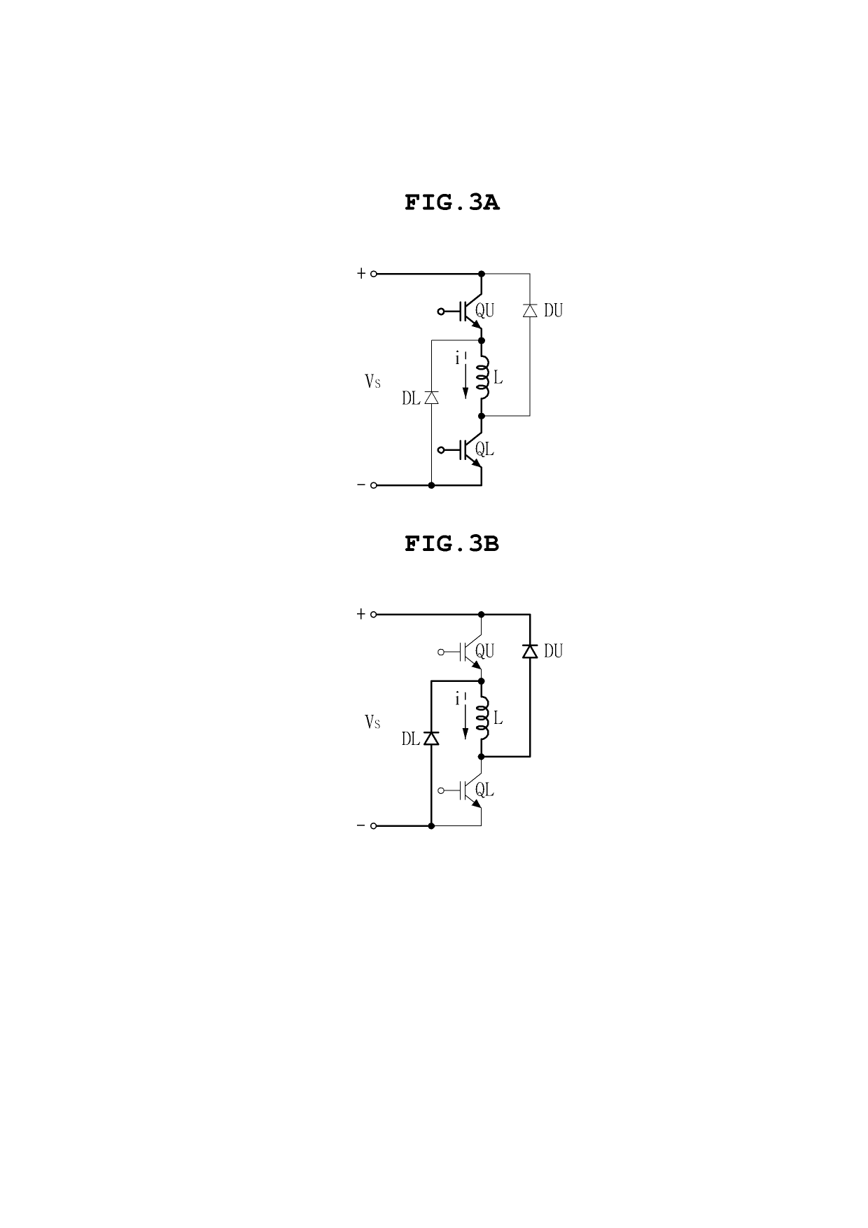

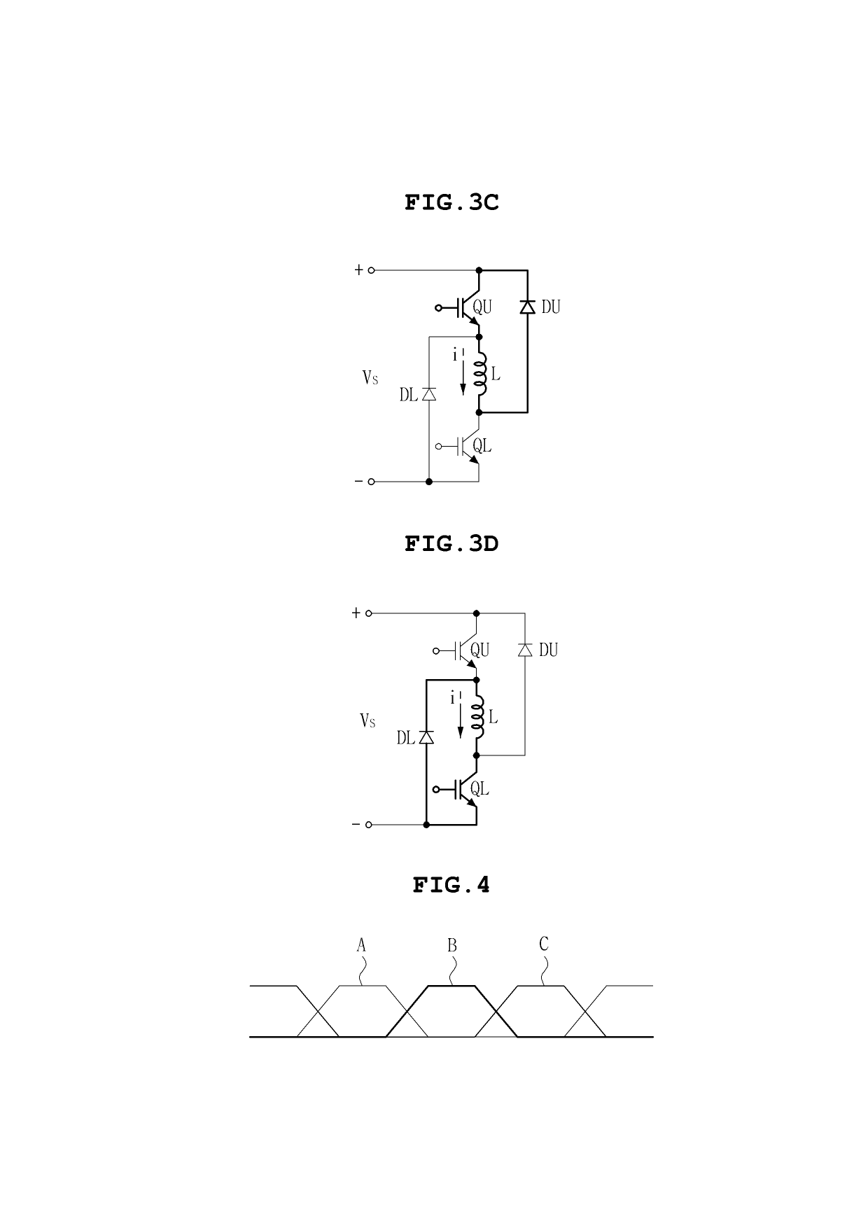

As shown in FIG. 3A, the mode 1 driving the transformer 100 turns on both of a upper switch QU and a lower switch QL corresponding to the corresponding coil L to be activated, such that the whole source power voltage Vs is applied to the corresponding coil to flowing winding current i therein.

Next, as shown in FIG. 3B, the mode 2 driving the transformer 100 reduces current by using a method of turning off the two switches QU and QL of a corresponding coil L and returning winding current to the capacitor C₁ side through the upper diode DU and the lower diode DL. In this case, current completely dissipates or a current amount is very small before inductance of the corresponding phase has a negative slope. In the mode 2, the voltage applied to the coil becomes negative source power voltage −Vs.

Further, as shown in FIG. 3C, the mode 3 driving the transformer 100 turns on only the upper switch QU of the corresponding coil L and circulates the winding current through the upper diode DU, the upper switch QU, and the winding. In this case, the voltage applied to the coil is 0.

Further, as shown in FIG. 3D, the mode 4 driving the transformer 100 turns on only the lower switch QL of the corresponding coil L and circulates the winding current through the lower diode DL, the lower switch QL, and the winding. In this case, the voltage applied to the coil is 0.

The transformer 100 having the operating modes is driven with the modes 1 to 4 according to the unipolar switching control signal provided from the control unit 200 to activate the corresponding coils L₁, L₂, and L₃.

Meanwhile, the control unit 200 outputs a unipolar switching control signal including a switching control signal turning on the pair of switches, a switching control signal turning on any one of the pair of switches, and a switching control signal turning off the pair of switches.

When the control unit 200 outputs the unipolar switching control signal configured as described above to the transformer 100, the transformer 100 uses the modes 1 to 4 to activate the corresponding coils L₁, L₂, and L₃.

The operation of the unipolar switching apparatus of the switched reluctance motor configured as described above will be described below in detail.

First, the control unit 200 outputs the unipolar switching control signal capable of inducing the reference current to the corresponding coil in a turn on period of the reference current of each coil, when the control unit 200 is supplied with the reference current of each coil.

In this case, an example of the reference current of each coil input to the control unit 200 is shown in FIG. 4, wherein line A represents the reference current to be induced to the coil L₁, line B represents the reference current to be induced to the coil L₂, and line C represents the reference current to be induced to the coil L₃.

As shown in FIG. 4, the control unit 200 outputs the unipolar switching control signal capable of inducing the reference current corresponding to the turn on period from the reference current of each coil.

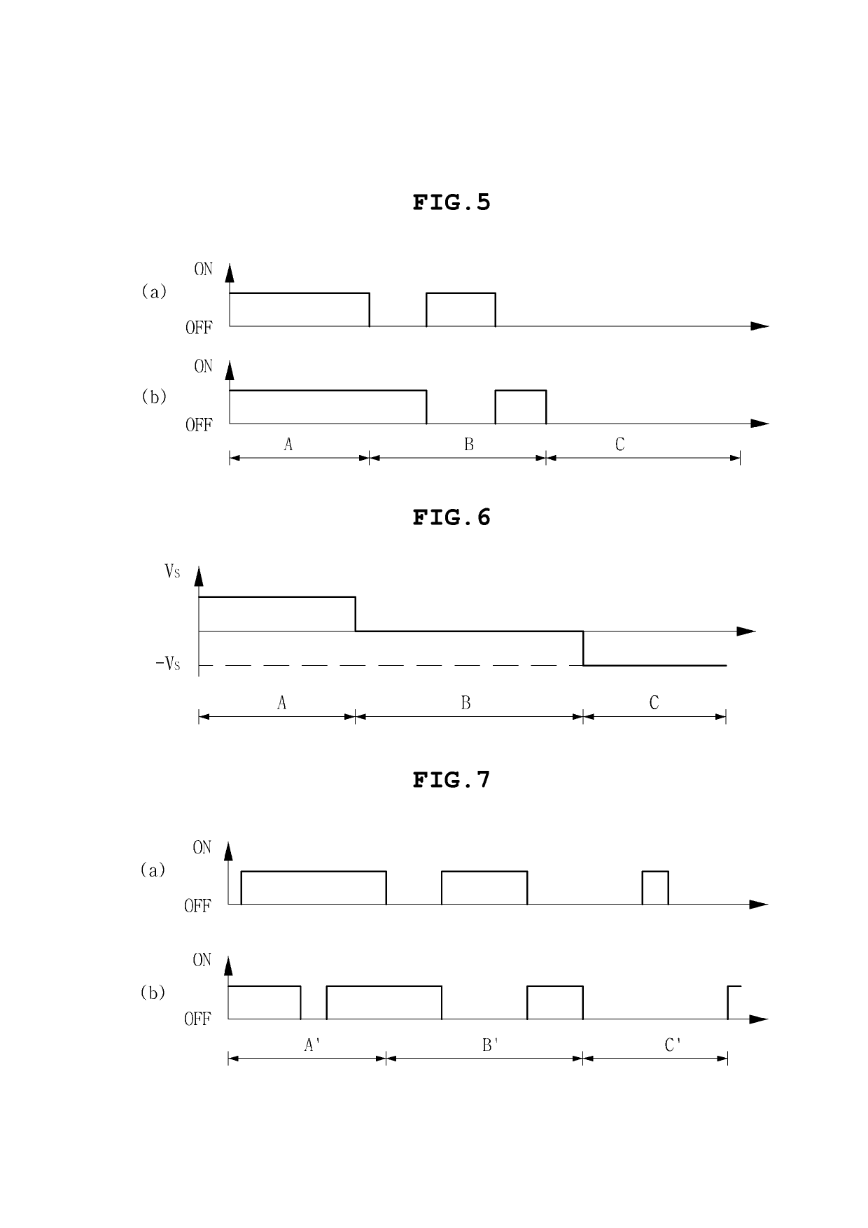

In this case, an example of the unipolar switching control signal output from the control unit 200 is shown in FIG. 5 (FIG. 5A shows the turn on or off of the upper switch and FIG. 5B shows the turn on or off of the lower switch), wherein the pair of switches of the corresponding coils L₁, L₂, and L₃ of the transformer 200 is turned on in time period A, the pair of switches of the corresponding coils L₁, L₂, and L₃ of the transformer are alternately turned on in time period B, and the pair of switches of the corresponding coils L₁, L₂, and L₃ corresponding to the transformer 200 is turned off in the time period C.

When the control unit 200 provides the unipolar switching control signal to the transformer 100, the transformer 100 is driven by the modes 1 to 4 according to the unipolar switching control signals provided from the control unit 200 to apply the source power voltage Vs to the corresponding coils L₁, L₂, and L₃ for a predetermined time, apply 0 voltage thereto for a predetermined time, and then, apply the −source power voltage −Vs thereto for a predetermined time, thereby activating the corresponding coils L₁, L₂, and L₃.

In this case, an example of allowing the transformer 100 to activate voltage to the corresponding coils L₁, L₂, and L₃ is shown in FIG. 6, wherein the source power voltage Vs is applied in period A of the unipolar switching control signal, 0 voltage is applied in period B, and −source power supply (−Vs) is applied in period C, thereby activating the corresponding coils L₁, L₂, and L₃.

Describing this in more detail, the transformer 100 is operated by the mode 1 in period A of the unipolar switching control signal output from the control unit 200 to turn on the pair of switches of the corresponding coils L₁, L₂, and L₃.

Further, the transformer 100 is operated by the mode 4 in period B of the unipolar switching control signal output from the control unit 200 to turn on the lower switches of the corresponding coils L₁, L₂, and L₃ and turn off the upper switches thereof, operated by the mode 3 to turn on the upper switches of the corresponding coils L₁, L₂, and L₃ and turn off the lower switches thereof, and then, again operated by mode 4 to turn on the lower switches of the corresponding coils L₁, L₂, and L₃ and turn off the upper switches thereof.

Thereafter, the transformer 100 is operated by the mode 2 in period C of the unipolar switching control signal output from the control unit 200 to turn off the pair of switches of the corresponding coils L₁, L₂, and L₃.

In this case, when the control unit 200 outputs the unipolar switching control signals capable of inducing the reference current to the corresponding coils in the turn on of the reference current of each coil, it sequentially activates three coils L₁, L₂, and L₃, such that the motor rotates.

Meanwhile, another example of the unipolar switching control signal is shown in FIG. 7, wherein one of the pair of switches of the corresponding coils L₁, L₂, and L₃ of the transformer 200 maintains the turn on state in period A′ and the other thereof generally maintains the turn on state but temporarily has the turn off state halfway.

Further, the pair of switches of the corresponding coils L₁, L₂, and L₃ of the transformer 200 is alternately turned on in time period B′.

Next, any one of the pair of switches of the corresponding coils L₁, L₂, and L₃ of the transformer 200 maintains the turn off state in time period C′ and the other one thereof generally maintains the turn off state but temporarily has the turn on state halfway.

When the control unit 200 provides the unipolar switching control signal to the transformer 100, the transformer 100 is driven by the modes 1 to 4 according to the unipolar switching control signals provided from the control unit 200 to apply the source power voltage Vs to the corresponding coils L₁, L₂, and L₃ for a predetermined time, apply 0 voltage thereto for a predetermined time, and then, apply the source power voltage Vs thereto for a predetermined time, thereby activate the corresponding coils L₁, L₂, and L₃.

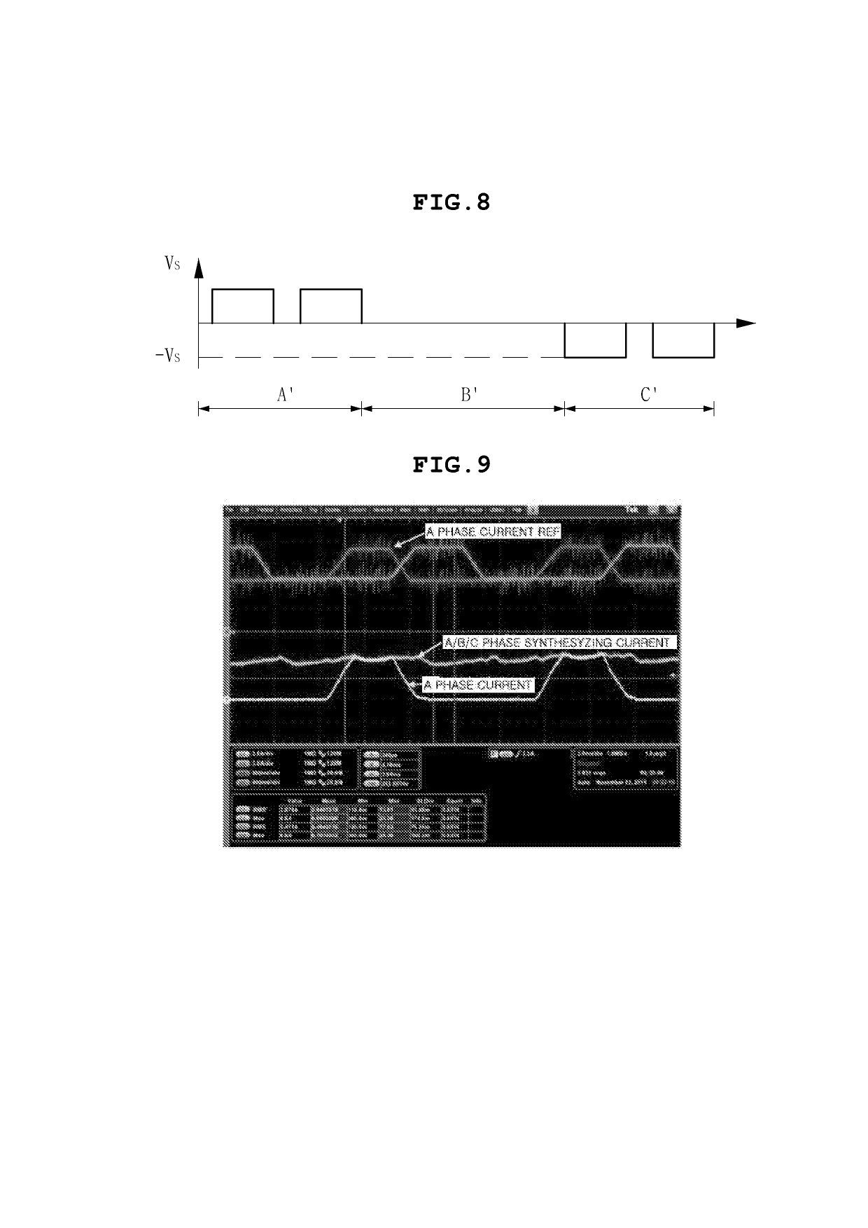

In this case, an example of voltage activated to the corresponding coils L₁, L₂, and L₃ by the transformer 100 is shown in FIG. 8, wherein the source power voltage Vs is generally applied in period A′ of the unipolar switching control signal output from the control unit 200 and 0 voltage is applied halfway.

Further, the corresponding coils L₁, L₂, and L₃ are activated by applying 0 voltage in period B′, generally applying −source power voltage −Vs, and temporarily applying 0 voltage halfway.

Describing this in more detail, the transformer 100 is operated by mode 1-mode 3-mode 1 in period A′ of the unipolar switching control signal output from the control unit 200 to activate the corresponding coils L₁, L₂, and L₃.

Further, the transformer 100 is operated by the mode 4 in period B′ of the unipolar switching control signal output from the control unit 200 to turn on the lower switches of the corresponding coils L₁, L₂, and L₃ and turn off the upper switches thereof, operated by the mode 3 to turn on the upper switches of the corresponding coils L₁, L₂, and L₃ and turn off the lower switches thereof, and then, operated by mode 4 to turn on the upper switches of the corresponding coils L₁, L₂, and L₃ and turn off the lower switches thereof.

Thereafter, the transformer 100 is operated by mode 4-mode 3-mode 4 in period C′ of the unipolar switching control signal output from the control unit 200 to retrieve the winding current of the corresponding coils L₁, L₂, and L₃.

As such, the preferred embodiment of the present invention applies the source power voltage Vs for a predetermined time, applies 0 voltage for a predetermined time, and then applies −source power voltage −Vs for a predetermined time to activate the corresponding coils L₁, L₂, and L₃, such that the following of the reference current is smoothly performed through the whole period as shown in FIG. 9.

Further, the following of the reference current is smoothly performed throughout the whole period, thereby minimizing the sudden change in magnetomotive force.

Therefore, the preferred embodiment of the present invention can minimize vibration and noise generated due to the sudden change in magnetomotive force.

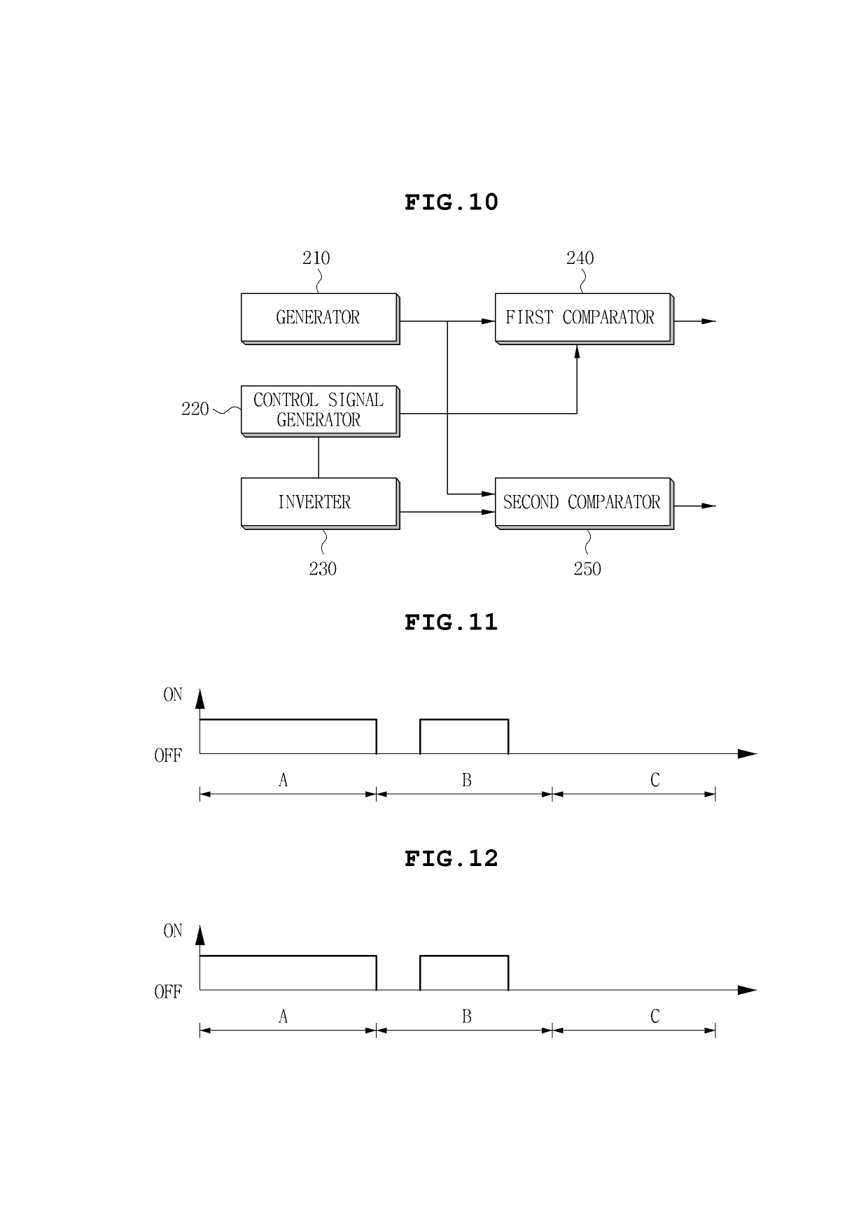

FIG. 10 is a detailed block diagram of a control unit of FIG. 1.

Referring to FIG. 10, the control unit of FIG. 1 includes a reference wave generator 210, a control signal generator 220, an inverter 230, a first comparator 240, and a second comparator 250.

The reference wave generator 210 generates and output a triangular wave of FIG. 11 that becomes a reference voltage. The triangular wave (line a) is a reference for generating the unipolar control signal later.

Further, the control signal generator 220 outputs the control signal including a positive control signal, a 0 control signal, and a negative control signal by dividing the corresponding turn on period into 3 time periods so as to induce the reference current to the corresponding coil in the turn on period of the reference current of each coil. The example is represented by line b in FIG. 11.

Next, the inverter 230 inverts and outputs the control signal output from the control signal generator 220. The example is represented by line c in FIG. 11. As such, the reason why the inversion control signal is required is that the switch connected with the coil requires a pairs of control signals.

Meanwhile, the first comparator 240 compares the triangular wave input from the reference wave generator 210 with the control signal input from the control signal generator 220 to output the positive switching control signal in a period in which the size in the triangular wave signal is larger and output the negative switching control signal in a period in which the size in the triangular signal is smaller. The example is represented by line c in FIG. 12.

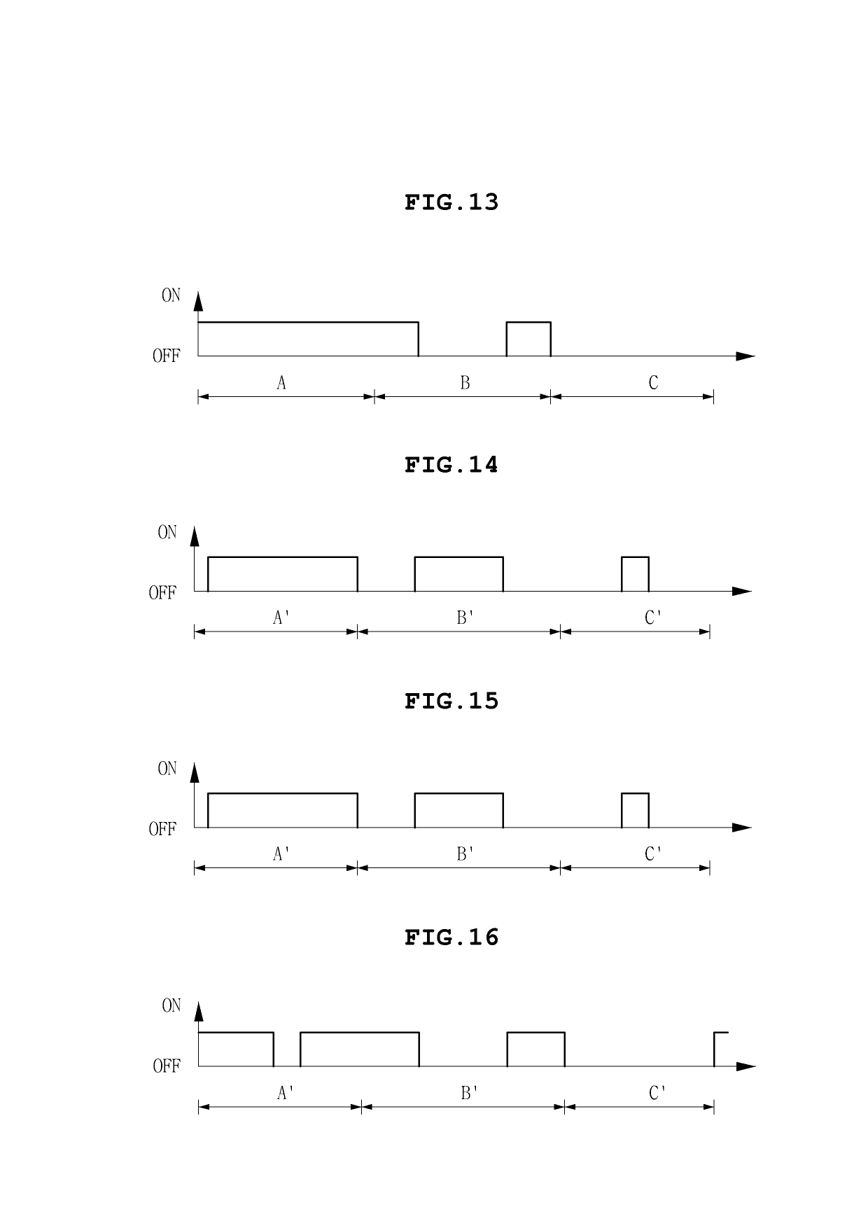

Next, the second comparator 250 compares the triangular wave input from the reference wave generator 210 with the inversion control signal input from the inverter 230 to output the positive switching control signal in a period in which the size in the triangular wave signal is larger and output the negative switching control signal in a period in which the size in the triangular signal is smaller. The example is represented by line c in FIG. 13.

The control unit allows the first comparator 240 to compare the triangular signal generated from the reference wave generator 210 with the control signal generated from the control signal generator 220 to generate and output the switching control signal of the upper switch.

Further, the second comparator 250 compares the triangular signal generated from the reference wave generator 210 with the control signal generated from the inverter 230 to generate and output the switching control signal of the lower switch.

The upper switching control signal and the lower switching control signal configure the unipolar switching control signal.

In this case, when the voltage of the triangular wave generated from the reference wave generator 210 is controlled as in FIG. 14, the unipolar switching control signal according to another preferred embodiment of the present invention may be generated as in FIGS. 15 and 16.

As such, the preferred embodiment of the present invention applies the source power voltage Vs for a predetermined time, applies 0 voltage for a predetermined time, and then applies −source power voltage −Vs for a predetermined time to activate the corresponding coils L₁, L₂, and L₃, such that the following of the reference current is smoothly performed through the whole period.

Further, the following of the reference current is smoothly performed throughout the whole period, thereby minimizing the sudden change in magentomotive force.

Therefore, the preferred embodiment of the present invention can minimize vibration and noise generated due to the sudden change in magnetomotive force.

As set forth above, the preferred embodiment of the present invention can smoothly follow the reference current throughout the whole period.

Further, the following of the reference current is smoothly performed throughout the whole period, thereby minimizing the sudden change in magentomotive force.

Therefore, the preferred embodiment of the present invention can minimize the noise generated due to the sudden change in magnetomotive force.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A unipolar switching apparatus of a switched reluctance motor, comprising:
a control unit outputting a unipolar switching control signal; and
a transformer driving an SRM according to the unipolar switching control signal output from the control unit.

2. The apparatus as set forth in claim 1, wherein the transformer includes:
a plurality of pairs of switches connected with each coil of the SRM in series; and
a plurality of pairs of diodes connected with each corresponding switch in parallel so as to re-circulate winding current of the corresponding coil when any one of the pair of switches is turned off.

3. The apparatus as set forth in claim 2, wherein the transformer further includes a capacitor connected with both ends of the plurality of pairs of switches in parallel to smooth and provide reference power voltage.

4. The apparatus of claim 1, wherein the control unit includes:
a reference wave generator generating and outputting a triangular wave that is reference voltage;
a control signal generator outputting a control signal including a positive control signal, a 0 control signal, and a negative control signal in a turn on period of reference current of each coil;
an inverter inverting and outputting the control signal output from the control signal generator;
a first comparator comparing a triangular wave input from the reference wave generator with the control signal input from the control signal generator to output a switching control signal of an upper switch; and
a second comparator comparing a triangular wave input from the reference wave generator with an inversion control signal output from the inverter to output a switching control signal of a lower switch.

5. The apparatus of claim 1, wherein the transformer according to the unipolar switching control signal output from the control unit applies source power voltage to the corresponding coil and then, applies 0 voltage thereto and applies −source power voltage thereto to activate the corresponding coil.

6. The apparatus of claim 1, wherein the transformer according to the unipolar switching control signal output from the control unit applies the source power voltage temporarily having the 0 voltage halfway to the corresponding coil and then, applies 0 voltage thereto and applies −source power voltage temporarily having a 0 voltage state halfway thereto to activate the corresponding coil.

7. A unipolar switching apparatus of a switched reluctance motor, comprising:
a transformer including a plurality of a pair of switches connected with each coil of an SRM in series, including a mode 1 state in which a pair of switches is turned on, a mode 2 state in which a pair of switches is turned off, a mode 3 state in which an upper switch is turned on and a lower switch is turned off, among a pair of switches, and a mode 4 state in which an upper switch is turned off and a lower switch is turned on, among a pair of switches, and using the modes 1 to 4 states according to a unipolar switching control signal to drive the SRM; and
a control unit outputting a unipolar switching control signal to the transformer,
wherein the transformer according to the unipolar switching control signal output from the control unit applies source power voltage to a corresponding coil and then, applies 0 voltage thereto and applies −source power voltage thereto to activate the corresponding coil.

8. The apparatus of claim 7, wherein the unipolar switching control signal output to the transformer from the control unit changes the state of the transformer from a mode 1 state to a mode 3 or 4 state and a mode 2 state.

9. The apparatus of claim 7, wherein the control unit includes:
a reference wave generator generating and outputting a triangular wave that is a reference voltage;
a control signal generator outputting a control signal including a positive control signal, a 0 control signal, and a negative control signal in a turn on period of reference current of each coil;
an inverter inverting and outputting the control signal output from the control signal generator;
a first comparator comparing a triangular wave input from the reference wave generator with the control signal input from the control signal generator to output a switching control signal of an upper switch; and
a second comparator comparing a triangular wave input from the reference wave generator with an inversion control signal output from the inverter to output a switching control signal of a lower switch.

10. The apparatus as set forth in claim 7, wherein the transformer according to the unipolar switching control signal output from the control unit applies the source power voltage temporarily having the 0 voltage halfway to the corresponding coil and then applies 0 voltage thereto, and applies −source power voltage temporarily having a 0 voltage state halfway thereto to activate the corresponding coil.
